(19) United States
(12) Patent Application Publication
(10) Pub. No.: US 2023/0416873 A1
(43) Pub. Date: Dec. 28, 2023

(54) ENVIRONMENTALLY FRIENDLY PROCESS TO OPTIMIZE COPPER DISSOLUTION AND RECOVER COPPER AND GOLD FROM ELECTRONIC WASTE

(71) Applicant: LEXMARK INTERNATIONAL, INC., Lexington, KY (US)

(72) Inventors: DINESH TYAGI, MEAD, CO (US); WEIMEI LUO, LOUISVILLE, CO (US); MARK THOMAS BELLINO, LOVELAND, CO (US)

(21) Appl. No.: 17/746,126

(22) Filed: May 17, 2022

(51) Int. Cl. C22B 15/00; C22B 11/00; C22B 7/00; C25C 1/20

(52) U.S. Cl. CPC C22B 15/0063; C25C 1/20; C22B 7/006; C22B 11/046

(57) ABSTRACT

The present invention is related generally to recovering metals from waste electronics, and more particularly to a process to recover copper and gold commonly found in waste printed circuit boards using a lixiviant containing a weak acid such as citric acid or acetic acid, a particular concentration of table salt and an oxidizer. By using this lixiviant, the copper found in the printed circuit board reacts to form copper salts and gold becomes detached. Importantly this recovery method of copper and gold found in waste PCBs is fast, does not pose environmental hazards and is economically feasible.

### CROSS REFERENCES TO REPLATED APPLICATIONS

None

### BACKGROUND

### 1. Field of the Disclosure

The present invention is related generally to recovering metals from waste electronics, and more particularly to a process to recover copper and gold commonly found in waste printed circuit boards (PCBs). This process contacts waste PCBs in a lixiviant solution containing a weak acid such as citric, acetic, or a combination of these acids, a particular concentration of table salt and an oxidizer. When waste PCBs are contacted and soaked in this lixiviant solution, the copper reacts to form copper salts and gold becomes detached and can be found in the lixiviant solution. Importantly this recovery method of copper and gold found in waste PCBs is fast, does not pose environmental hazards and is economically feasible.

### 2. Description of the Related Art

The production of electrical and electronic equipment has been rapidly increasing due to the revolution of information technology. All electrical and electronic equipment such as smart phones, tablets, desktop/laptop computers contain PCBs. Importantly, these PCBs contain a significant amount of valuable base and precious metals, including copper, zinc, lead, nickel and tin and valuable precious metals including gold, silver, and palladium. Gold, having superior chemical resistance and electrical conductivity, is widely electroplated on top of copper, copper/nickel electrical contacts in PCBs for added protection from rust, damage and or corrosion.

Technological advancements in electronic equipment have shortened their life span and have caused a massive tonnage of waste (‘e-waste’) to be produced. This e-waste causes multiple environmental challenges. Currently, the base and precious metals contained in PCBs are not sufficiently recovered prior to the disposal of e-waste. E-waste can be disposed of through incineration or placed in a landfill. Both disposal options present environmental challenges. Incineration releases toxins into the air. Landfilling electronic waste can contaminate underground water and soil.

In addition to the recovery of precious and base metals from e-waste being desirable from an environmental standpoint, it is also desirable from an economic standpoint. Cost effective methods of recovering base and precious metals from e-waste are desirable due to the source of income due to the high economic value of gold, silver, palladium, and copper, as well as other metals.

It is therefore desirable to have an adequate recycling process of e-waste, especially waste PCBs, that will prevent environmental pollution. Also desirable is a cost-effective recovery process of metals especially gold and copper. Currently, methods based on pyrometallurgical and hydrometallurgy techniques are used for the recovery of these metals on PCBs.

Known pyrometallurgical processes are not cost effective nor environmentally friendly on account of the of the use of high temperatures on the waste PCBs to recover the base and precious metals, leading to the production of hazardous gases into the air. Additionally, pyrometallurgical processes are energy intensive and require high cost and capital to start up and maintain the recovery/recycling operation. Based on the above-described limitations of using a pyrometallurgy process to recover metals from waste PCBs, hydrometallurgical processes are preferred.

Hydrometallurgical processes of recovery of base and precious metals, especially gold electroplated on top of the copper, from waste PCBs are usually done at a lower cost, have a reduced environmental impact because of the low gas and dust formation, and have higher gold recoveries compared to pyrometallurgical processes. Hydrometallurgical method for gold recovery from security chip and PCBs typically consists of cyanide and non-cyanide processes to dissolve and recover gold. The process typically involves multiple steps like grinding, and leaching, extraction, cementation, or electrowinning.

Due to the high toxicity and environmental impact of using a hydrometallurgical process employing cyanide, there has been a desire to find non-cyanine hydrometallurgical alternatives in recent years. Several known non-cyanide hydrometallurgical processes include the use of a leaching solution having a strong acid in combination with an oxidizing agent such as aqua regia (HNO3+3HCl). Another known leaching solution uses thiosulfate/thiourea. A third leaching solution uses iodine/iodide. However, the use of these leaching solutions to recover gold in PCBs have known drawbacks including high cost and the use of toxic reagents in the leaching solutions. Accordingly, it is desirable to have a hydrometallurgical process to recover gold from e-waste that is both cost effective and environmentally friendly.

### SUMMARY

The present invention is related generally to recovering metals from waste electronics, and more particularly to a process which optimizes copper dissolution and recovers copper and gold commonly found in waste printed circuit boards (PCBs) without the need for strong and costly chemicals or toxic leaching. This metal recovery process contacts waste PCBs in a lixiviant solution containing a weak acid such as citric, acetic, or a combination of these acids, a particular concentration of table salt and an oxidizer. The salt concentration is less than 30% weight of the lixiviant solution, preferably, 2% to 10% by weight. Additionally, the weak acid to salt ratio in the lixiviant solution in the range of 1 to 15, preferably, 2 to 13. When waste PCBs are contacted and soaked in this particular lixiviant solution, the copper in the PCBs reacts to form copper salts and gold deposited onto the surface of copper contact becomes detached and can be recovered from the lixiviant solution using techniques including electrowinning, precipitation or solvent extraction. The extracted/leached copper in the lixiviant solution could be either electrically deposited onto an electrode or could be converted to a useful salt. Importantly this recovery method of copper and gold found in waste PCBs is fast, does not pose environmental hazards and is economically feasible.

### BRIEF DESCRIPTION OF THE DRAWINGS

FIG. 1 is a graph showing the effect on the pH of the lixiviant solution containing a weak acid and salt concentration.

FIG. 2 is a graph showing the effect on the pH of the lixiviant solution containing a weak acid and salt concentration.

FIG. 3 is a UV-VIS chart showing the progress of the copper dissolution.

### DETAILED DESCRIPTION

Typical hydrometallurgical processes of recovering precious metals from e-waste involves leaching the copper from the e-waste by using strong acids and/or base in a leaching/lixiviant solution. Such chemicals generate hazardous waste and pose safety hazards. As pointed out above, copper is extensively used in PCBs because of its excellent electrical conductivity. However, copper can easily be oxidized, leading to the loss of electrical contacts. To prevent this loss of conductivity, copper contacts in PCBs are usually coated with gold to maintain good connections. Nickel or tin are also used but do not have good electrical conduction.

Weak acids like acetic acid and citric acid do not attack the copper contacts found in PCBs but these weak acids can dissolve copper oxide. It is known that these weak acids are often used to dissolve and remove dull oxide layer from copper artifacts. Theoretically, it is possible to dissolve an all-copper penny by repeated dipping in a solution containing these acids. After the copper oxide layer has been dissolved, the copper exposed to air will regenerate a fresh copper oxide layer which can then be dissolved by dipping in the weak acid solution again. If such a process is repeated many times, it is possible to dissolve the entire penny.

One method of supplying oxygen for the oxidation of copper element is either by the addition of hydrogen peroxide or by bubbling air/oxygen through the weak acid solution containing copper artifacts.

The inventors of the present inventive process have found that this copper oxide reaction could be further enhanced and sped up by using a lixiviant solution containing a weak acid, such as citric acid, acetic acid or a combination of both acids, and common table salt (NaCl) in a particular concentration with any choice of oxygen introduction. The salt concentration is less than 30% weight of the lixiviant solution, preferably, 2% to 10% by weight. Additionally, the weak acid to salt ratio in the lixiviant solution in the range of 1 to 15, preferably, 2 to 13.

The acetic acid in vinegar has the following chemical structure:

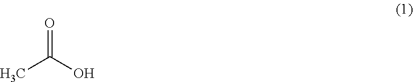

The copper oxide reacts with the weak acetic acid to from copper acetate which is soluble in water.

CuO+2CH₃COOH→Cu(CH₃COO)₂+H₂O (2)

Citric Acid has the following chemical structure

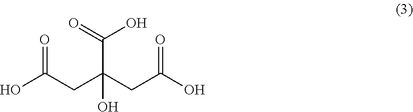 [SMILES: O=C(O)CC(O)(CC(=O)O)C(=O)O]

There are several possible reactions of citric acid with copper and copper oxide that have been reported in the prior art:

2CuO+C6H8O7=Cu2C6H4O7+2H2O (4)

The exact mechanism for what happens when common table salt (NaCl) is added to the weak acid lixiviant solution in not totally clear. There are several outcomes: (1) Salt could act as an electrolyte and promote a redox process. (2) Salt could act as a catalyst. (3) Na+ ions enhance the dissolution of the weak acid in water, pushing reaction to the right. (4) Chloride can penetrate the copper oxide layer and promote dissolution of copper.

The inventors discovered that the addition of common table salt to the lixiviant solution containing only weak acid and an oxidizer surprisingly accelerated the copper dissolution. The salt concentration is less than 30% weight of the lixiviant solution, preferably, 2% to 10% by weight. Additionally, the weak acid to salt ratio in the lixiviant solution in the range of 1 to 15, preferably, 2 to 13.

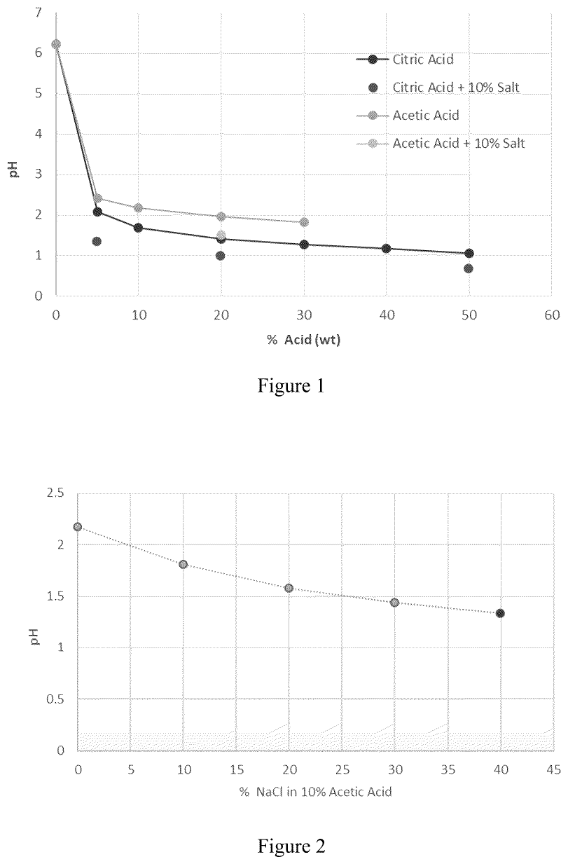

The pH of the acetic and citric acids is also different and the pH changes with the concentration of the weak acid used for copper dissolution. Moreover, as shown in FIG. 1, when common salt is added to any of these acid solutions, the pH drops further by about 0.4 pH units for every 10% addition of salt. It is unclear if some small quantity of HCl is being formed but appears unlikely. A fixed drop of pH at all acid concentrations argues against that some quantity of HCl is being formed as well. The inventors believe that acid dissolution is being promoted by the salt presence in the lixiviant solution. Moreover, as shown in FIG. 2, the addition of salt to the acetic acid solution also lowers the pH.

The data in FIGS. 1 and 2 suggest that by controlling the amount of citric or acetic acid as well as the salt concentration in the lixiviant solution, the effective optimum pH could be achieved for copper dissolution in waste PCBs and well as the aiding in the delamination of the gold electroplated on top of the copper contacts. The effective pH of the lixiviant solution is less than 2.3, preferably in the range 0.6 to 2.2.

The progress of the copper dissolution reaction was followed using temperature data, pH data and UV-VIS absorption. Different concentrations of acetic acid, citric acid and salt were tested to determine most efficient process for copper dissolution. In Experiment 1, a lixiviant solution having the salt (NaCl) and Citric acid (CA) amounts in grams as listed in Table 1 below and mixed with 100 mls of 3% hydrogen peroxide and 50 grams of washed and shredded PCBs.

TABLE 1

| | CA(g) | NaCl(g) |
|---|---|---|
| Sample 1 | 20 | 5 |
| Sample 2 | 20 | 10 |
| Sample 3 | 20 | 20 |
| Sample 4 | 10 | 10 |
| Sample 5 | 40 | 10 |

In Experiment 2, following ratios of citric acid and salt listed in Table 2 were used in the lixiviant solution mixed with 100 mls of 3% hydrogen peroxide and 50 grams of washed and un-shredded PCBs.

TABLE 2

| | CA(g) | NaCl |
|---|---|---|
| Sample A | 10 | 10 |
| Sample B | 20 | 20 |
| Sample C | 30 | 30 |
| Sample D | 40 | 10 |

In Experiment 3 the ratio of salt was increased in the lixiviant solution to ensure that salt to citric acid was stoichiometrically matched. In Experiment 3, a lixiviant solution having the salt (NaCl) and Citric acid (CA) amounts in grams as listed in Table 3 below and mixed with 100 mls of 3% hydrogen peroxide and 50 grams of washed and shredded PCBs.

TABLE 3

| | CA(g) | NaCl |
|---|---|---|
| Sample A | 10 | 12 |
| Sample B | 20 | 24 |
| Sample C | 30 | 36 |
| Sample D | 40 | 24 |

The reactions in Experiments 1, 2 and 3 were followed by measuring the pH and temperature. UV-VIS reaction progress was monitored by removing 1 ml of lixiviant solution and diluting the 1 ml of lixiviant solution with 2 mls of DI water. UV-VIS scans were performed from 325 to 1100 nm using a Thermo Fisher GYNESYS 50 UV-VIS spectrophotometer. End of the reactions in Experiments 1, 2 and 3 was assumed when the peak of the UV-VIS spectra has attained maximum. Similarly, the completion of reaction could be indicated by measuring the pH throughout the reaction. As the weak citric acid is being used to remove copper in the un-shredded PCBs, the pH of the lixiviant solution rises. When pH ceases to rise any further or the change in pH slows down significantly, it suggests the end of the desired reaction.

In Experiment 4 both acetic and citric acids were compared at various salt concentrations as shown in the Table 4 below. The objective of Experiment 4 was to ascertain the effect of the acid type used in the lixiviant solution, preferable acid concentration and preferable acid to salt ratio to obtain optimum gold recovery.

TABLE 4

| | Reaction | | | | | | | |
|---|---|---|---|---|---|---|---|---|
| Materials | 4-A | 4-B | 4-C | 4-D | 4-E | 4-F | 4-G | 4-H |
| Acetic Acid, g | 12.5 | 12.5 | 25 | 25 | | | | |
| Citric Acid, g | | | | | 12.5 | 12.5 | 25 | 25 |
| H₂O₂, g | 10 | 10 | 10 | 10 | 10 | 10 | 10 | 10 |
| H₂0, g | 100 | 100 | 100 | 100 | 100 | 100 | 100 | 100 |
| NaCl, g | 2 | 5 | 2 | 5 | 2 | 5 | 2 | 5 |
| Chip, g | 50 | 50 | 50 | 50 | 50 | 50 | 50 | 50 |
| Acid/ H₂O₂ | 1.25 | 1.25 | 2.5 | 2.5 | 1.25 | 1.25 | 2.5 | 2.5 |
| Acid/Chips | 0.25 | 0.25 | 0.5 | 0.5 | 0.25 | 0.25 | 0.5 | 0.5 |
| Acid/NaCl | 6.25 | 2.5 | 12.5 | 5 | 6.25 | 2.5 | 12.5 | 5 |

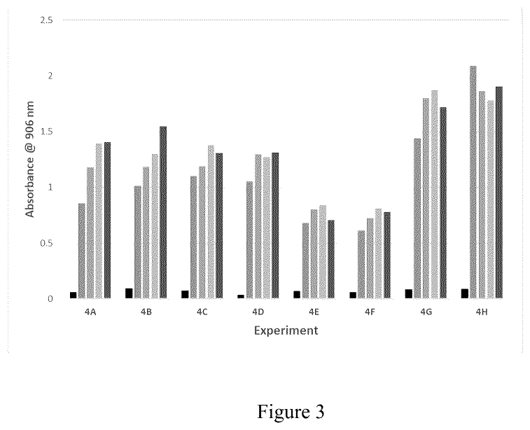

In reviewing FIG. 3, the UV-VIS results suggest that higher acid concentration and salt content were critical in speeding the reaction rate. Hourly samples from Experiments 4A-4H were taken and measured by UV-VIS in a standard cuvette (hour 1—black, hour 2—orange, hour 3—gray, hour 4—yellow, hour 5—blue). In general, the completion of reaction was achieved faster with citric acid the reaction was further enhanced by increased salt concentration in the lixiviant solution. The optimum concentration of the salt in the lixiviant solution is less than 30% by weight in the lixiviant solution. However, acetic acid is an acceptable alternative to using citric acid in the lixiviant solution in combination with an optimum salt concentration of less than 30% by weight of the lixiviant solution.

In various other experiments involving acetic or citric acid and salt, following experimental plans were used. The lixiviant solution consisted of different amounts of acid %; salt %; hydrogen peroxide %; acid/chips ratios; and acid/salt % ratio as set forth in Table 5 below. The stripping or delamination time (copper becomes copper salt and dissolves in the lixiviant solution after reacting with the weak acid and the electroplated gold becomes separated or delaminated from the chips) for the gold is also set forth in Table 5.

TABLE 5

| | | | | | | RATIO | | STRIPPING |
|---|---|---|---|---|---|---|---|---|
| | UNSHREDDED | | CONCENTRATION¹ | | | ACID/ | ACID/ | TIME FOR |
| EXPT# | CHIPS, g | ACID | ACID % | NaCl % | H₂O₂ % | CHIPS | NaCl% | GOLD, hrs. |
| 1 | 500 | acetic | 8.33 | 1.2 | 1.7 | 0.6 | 12 | 24 |
| 2 | 500 | citric | 8.33 | 1.2 | 1.7 | 0.6 | 12 | 24 |
| 3 | 1000 | acetic | 11.3 | 1.1 | 1.5 | 0.3 | 12 | 24 |
| 4 | 1000 | acetic | 17.6 | 1.1 | 1.5 | 0.5 | 20 | 24 |
| 5 | 500 | citric | 5.2 | 2.7 | 2 | 0.23 | 2 | 6 |
| 6 | 500 | citric | 9.9 | 2.6 | 2 | 0.46 | 4 | 6 |
| 7 | 500 | citric | 5.3 | 1.4 | 1.9 | 0.23 | 4 | 24 |
| 8 | 500 | citric | 10 | 1.3 | 1.8 | 0.46 | 8 | 24 |
| 9 | 500 | citric | 5.1 | 4 | 1.9 | 0.23 | 1.3 | 5 |
| 10 | 500 | citric | 5.1 | 5.3 | 1.8 | 0.23 | 1 | 5 |
| 11 | 500 | acetic | 5.1 | 4 | 1.9 | 0.23 | 1.3 | n/a |
| 12 | 500 | acetic | 5.1 | 5.3 | 1.8 | 0.23 | 1 | n/a |
| 13 | 500 | citric | 2.38 | 5.3 | 1.9 | 0.2 | 0.8 | 5 |
| 14 | 500 | citric | 2.38 | 6.6 | 1.8 | 0.2 | 0.7 | 24 |
| 15 | 500 | acetic | 8.6 | 3.9 | 1.8 | 0.4 | 2.2 | 24 |
| 16 | 500 | acetic | 8.1 | 3.6 | 3.4 | 0.4 | 2.2 | 24 |

In all the experiments described in Table 5, gold flakes were clearly isolated and identified by EDS and ICP testing results. When a metal washer was added to the lixiviant solution in several experiments listed in Table 4, it was found that overnight a copper coating had covered the washer, confirming the presence of copper ions. This copper ion recovery could be sped up by setting up a electrical cell and by applying some desired potential (i.e. by electrowinning). Also, when the lixiviant solution was allowed to dry slowly, aqua-green crystals of copper acetate or copper citrate were recovered.

What is claimed is:

1. A method to recover copper and gold from electronic waste, the method comprising the steps of:
(1) Preparing a single lixiviant solution containing a weak acid, an oxidizer, and a salt wherein a concentration of the salt is less than 30% by weight of the single lixiviant solution, the weak acid to the salt ratio in the lixiviant solution is 1 gram to 15 grams; and the pH of the single lixiviant solution is less than 2.3;
(2) Contacting and soaking electronic waste containing printed circuit boards having gold electroplated on top of copper electrical contacts with the single lixiviant solution wherein copper in the printed circuit boards reacts to form copper salts and the gold electroplated on top of the copper electrical contacts becomes detached from the electrical contacts in the single lixiviant solution;
(3) Recovering the copper salts and detached gold in the single lixiviant solution.

2. The method to recover copper and gold from electronic waste of claim 1, wherein the weak acid is citric acid.

3. The method to recover copper and gold from electronic waste of claim 1, wherein the salt is table salt (NaCl).

4. The method to recover copper and gold from electronic waste of claim 1, wherein the oxidizer is hydrogen peroxide.

5. The method to recover copper and gold from electronic waste of claim 3, wherein the concentration of the table salt (NaCl) is between 2% and 10% by weight of the single lixiviant solution.

6. The method to recover copper and gold from electronic waste of claim 1, wherein the ratio of the weak acid to the salt in the single lixiviant solution is 2 grams to 13 grams.

7. The method to recover copper and gold from electronic waste of claim 1, wherein the detached gold is recovered by electrowinning, precipitation or solvent extraction.

8. The method to recover copper and gold from electronic waste of claim 1, wherein the pH of the single lixiviant solution is between 0.6 and 2.2.

9. The method to recover copper and gold from electronic waste of claim 1, wherein the speed of the copper salt recovery is increased by placing the single lixiviant solution in an electrical cell and applying a desired potential to the electrical cell containing the single lixiviant solution.
